(19) United States
(12) Patent Application Publication
(10) Pub. No.: US 2013/0041669 A1
(43) Pub. Date: Feb. 14, 2013

(54) SPEECH OUTPUT WITH CONFIDENCE INDICATION

(71) Applicant: International Business Machines Corporation, Armonk, NY (US)

(72) Inventors: Shay Ben-David, Haifa (IL); Ron Hoory, Haifa (IL)

(73) Assignee: INTERNATIONAL BUSINESS MACHINES CORPORATION, Armonk, NY (US)

(21) Appl. No.: 13/654,295

(22) Filed: Oct. 17, 2012

Related U.S. Application Data
(63) Continuation of application No. 12/819,203, filed on Jun. 20, 2010.

(51) Int. Cl. G10L 13/08

(52) U.S. Cl. 704/260; 704/E13.011

(57) ABSTRACT

A method, system, and computer program product are provided for speech output with confidence indication. The method includes receiving a confidence score for segments of speech or text to be synthesized to speech. The method includes modifying a speech segment by altering one or more parameters of the speech proportionally to the confidence score.

### CROSS-REFERENCE TO RELATED APPLICATION

This application is a continuation application of U.S. patent application Ser. No. 12/819,203 entitled, “ SPEECH OUTPUT WITH CONFIDENCE INDICATION”, filed on Jun. 20, 2010 and is assigned to the same assignee in the present application, contents of which are incorporated by reference herein in its entirety.

### BACKGROUND

This invention relates to the field of speech output. In particular, the invention relates to speech output with confidence indication.

Text-to-speech (TTS) synthesis is used in various environments to convert normal language text into speech. Speech synthesis is the artificial production of human speech. A computer system used for this purpose is called a speech synthesizer, and can be implemented in software or hardware. The output of a TTS synthesis system is dependent on the accuracy of the text input.

In one example, environment TTS synthesis is used in speech-to-speech translation systems. Speech-to-speech translation systems are typically made of a cascading of a speech-to-text engine (also known as an Automatic Speech Recognition—ASR), a machine translation engine (MT), and a text synthesis engine (Text-to-Speech, TTS). The accuracy of such systems is often a problem. ASR engines suffer from recognition errors and MT engines from translation errors, especially on inaccurate input as a result of ASR recognition errors, and therefore the speech output includes these often compounded errors.

Other forms of speech output (not synthesized from text) may also contain errors or a lack of confidence in the output.

### BRIEF SUMMARY

According to a first aspect of the present invention there is provided a method for speech output with confidence indication, comprising: receiving a confidence score for segments of speech or text to be synthesized to speech; and modifying a speech segment for output by altering one or more parameters of the speech proportionally to the confidence score; wherein said steps are implemented in either: computer hardware configured to perform said identifying, tracing, and providing steps, or computer software embodied in a non-transitory, tangible, computer-readable storage medium.

According to a second aspect of the present invention there is provided a system for speech output with confidence indication, comprising: a processor; a confidence score receiver for segments of speech or text to be synthesized to speech; and a confidence indicating component for modifying a speech segment for output by altering one or more parameters of the speech proportionally to the confidence score.

According to a third aspect of the present invention there is provided a computer program product for speech output with confidence indication, the computer program product comprising: a computer readable storage medium having computer readable program code embodied therewith, the computer readable program code comprising: computer readable program code configured to: receive a confidence score for segments of speech or text to be synthesized to speech; and modify a speech segment for output by altering one or more parameters of the speech proportionally to the confidence score.

According to a fourth aspect of the present invention there is provided a service provided to a customer over a network for speech output with confidence indication, comprising: receiving a confidence score for segments of speech or text to be synthesized to speech; and modifying a speech segment for output by altering one or more parameters of the speech proportionally to the confidence score; wherein said steps are implemented in either: computer hardware configured to perform said identifying, tracing, and providing steps, or computer software embodied in a non-transitory, tangible, computer-readable storage medium.

### BRIEF DESCRIPTION OF THE SEVERAL VIEWS OF THE DRAWINGS

The subject matter regarded as the invention is particularly pointed out and distinctly claimed in the concluding portion of the specification. The invention, both as to organization and method of operation, together with objects, features, and advantages thereof, may best be understood by reference to the following detailed description when read with the accompanying drawings in which:

FIG. 1 is a block diagram of a speech-to-speech system as known in the prior art;

FIGS. 2A and 2B are block diagrams of embodiments of a system in accordance with the present invention;

FIG. 3 is a block diagram of a computer system in which the present invention may be implemented;

FIG. 4 is a flow diagram of a method in accordance with an aspect of the present invention; and

FIG. 5 is a flow diagram of a method in accordance with an aspect of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numbers may be repeated among the figures to indicate corresponding or analogous features.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

A method, system and computer program product are described for speech output with a confidence indication. Speech output may include playback speech or speech synthesized from text.

The described method marks speech output using a confidence score in the form of a value or measure. The confidence score is provided to the speech output phase. Words (or phrase or utterances depending on the context) with low confidence are audibly enhanced differently to words with high confidence. In addition, in a multi-modal system, the speech output may be supplemented by a visual output including a visual gauge of the confidence score.

In one embodiment, the speech output may be any played back speech that has associated confidence. For example, there may be a situation in which there are recorded answers, each associated with a confidence (as a trivial case, suppose the answers are “yes” with confidence 80% and “no” with confidence 20%). The system will play back the answer with the highest confidence, but with an audible or visual indication of the confidence level.

In a second embodiment, the marking may be provided by modifying speech synthesized from text by altering one or more parameters of the synthesized speech proportionally to the confidence value. Such marking might be performed by expressive TTS, which would modify the synthesized speech to sound less or more confident. Such effects may by achieved by the TTS system, by modifying parameters like volume, pitch, speech rhythm, speech spectrum etc. or by using a voice dataset recorded with different levels of confidence.

In a third embodiment, the speech output may be synthesized speech with post synthesis effects, such as additive noise, added to indicate confidence values in the speech output.

In further embodiment which may be used in combination with the other embodiments, if the output means are multimodal, the confidence level may be presented on a visual gauge while the speech output is heard by the user.

The described method may be applied to stochastic (probabilistic) systems in which the output is speech. Probabilistic systems can estimate the confidence that their output is correct, and even provide several candidates in their output, each with its respective confidence (for example, N-Best).

The confidence indication allows a user to distinguish words with a low confidence (which might contain misleading data) and gives a user the opportunity to verify and ask for reassurance on critical words with low confidence.

The described method may be used in any speech output systems with confidence measure. In one embodiment, the described speech synthesis output with confidence indication is applied in a machine translation system (MT) with speech output and, more particularly, in a speech-to-speech translation system (S2S) in which multiple errors may be generated.

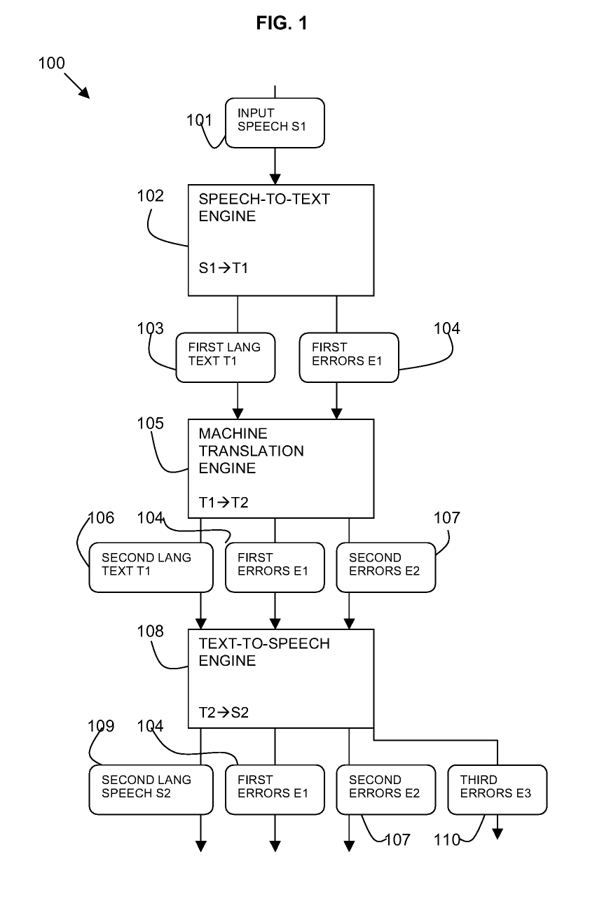

Referring to FIG. 1, an example scenario is shown with a basic configuration of a speech-to-speech (S2S) translation system 100 as known in the prior art. Such S2S systems are usually trained for single language pairs (source and destination).

An input speech (S1) 101 is received at a speech-to-text engine 102 such as an automatic speech recognition engine (ASR). The speech-to-text engine 102 converts the input speech (S1) 101 into a first language text (T1) 103 which is output from the speech-to-text engine 102. Errors may be produced during the conversion of the input speech (S1) 101 to the first language text (T1) 103 by the speech-to-text engine 102. Such errors are referred to as first errors (E1) 104.

The first language text (T1) 103 including any first errors (E1) 104 is input to a machine translation engine (MT) 105. The MT engine 105 translates the first language text (T1) 103 into a second language text (T2) 106 for output. This translation will include any first errors (E1) 104 and may additionally generate second errors (E2) 107 in the translation process.

The second language text (T2) 106 including any first and second errors (E1, E2) 104, 107 are input to a text-to-speech (TTS) synthesis engine 108 where it is synthesized into output speech (S2) 109. The output speech (S2) 109 will include the first and second errors (E1, E2) 104. 107. The output speech (S2) 109 may also include third errors (E3) 110 caused by the TTS synthesis engine 108 which would typically be pronunciation errors.

A confidence measures can be generated at different stages of a process. In the embodiment described in relation to FIG. 1, a confidence measure can be generated by the speech-to-text engine 102 and by the MT engine 105 and applied to the outputs from these engines. A confidence measure may also be generated by the TTS synthesis engine 108.

When speech is converted to text in an ASR unit, schematically, it is first converted to phonemes. Typically, there are several phoneme candidates for each ‘word’ fragment, each with its own probability. In the second stage, those phoneme candidates are projected into valid words. Typically, there are several word candidates, each with its own probability. In the third stage, those words are projected into valid sentences. Typically there are several sentence candidates, each with its own probability. The speech synthesizer receives those sentences (typically after MT) with each word/sentence segment having a confidence score.

Confidence measures can be generated at each stage of a process. Many different confidence scoring systems are known in the art and the following are some example systems which may be used.

In automatic speech recognition systems confidence measures can be generated. Typically, the further the test data is from the trained models, the more likely errors will arise. By extracting such observations during recognition, a confidence classifier can be trained. (see “Recognition Confidence Scoring for Use in Speech understanding Systems” by T J Haxen et al, Proc. ISCA Tutorial and Research Workshop, ASR2000, Paris, France, September 2000). During recognition of a test utterance, a speech recogniser generates a feature vector that is passed to a separate classifier where a confidence score is generated. This score is passed to the natural language understanding component of the system.

In some ASR systems, confidence measures are based on receiving from a recognition engine a N-best list of hypotheses and scores for each hypothesis. The recognition engine outputs a segmented, scored, N-best list and/or word lattice using a HMM speech recogniser and spelling recognizer (see U.S. Pat. No. 5,712,957).

In machine translation engines confidence measures can be generated. For example, U.S. Pat. No. 7,496,496 describes a machine translation system is trained to generate confidence scores indicative of a quality of a translation result. A source string is translated with a machine translator to generate a target string. Features indicative of translation operations performed are extracted from the machine translator. A trusted entity-assigned translation score is obtained and is indicative of a trusted entity-assigned translation quality of the translated string. A relationship between a subset of the extracted features and the trusted entity-assigned translation score is identified.

In text-to-speech engines, a confidence measure can be provided. For example, U.S. Pat. No. 6,725,199 describes a confidence measure provided by a maximum a priori probability (MAP) classifier or an artificial neural network. The classifier is trained against a series of utterances scored using a traditional scoring approach. For each utterance, the classifier is presented with the extracted confidence features and listening scores. The type of classifier must be able to model the correlation between the confidence features and the listening scores.

Typically, a confidence score is added to the text as metadata. A common way to represent it is through XML (Extensible Markup Language) file, when each speech unit has its confidence score. The speech unit may be phoneme, word, or entire sentence (utterance).

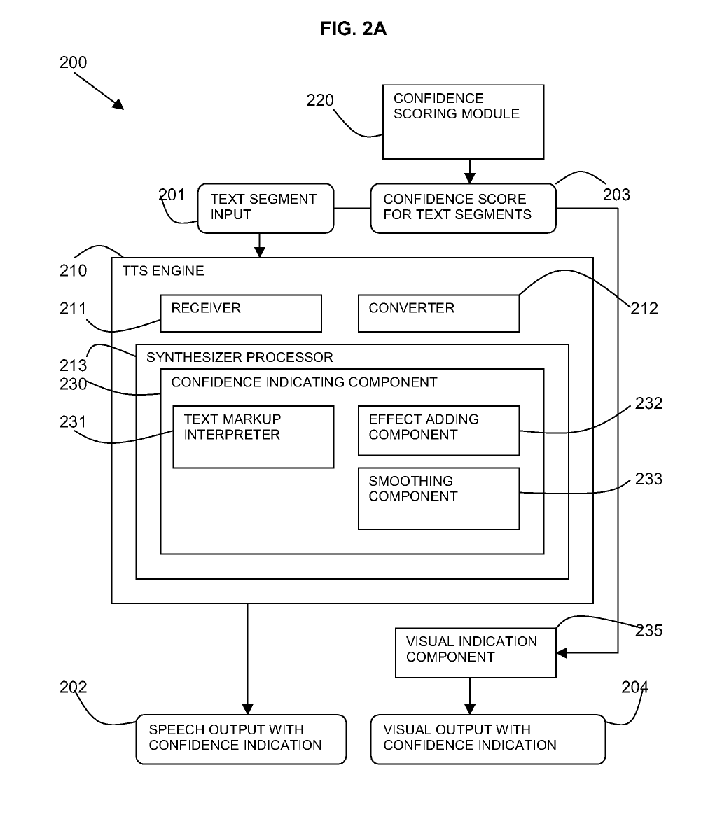

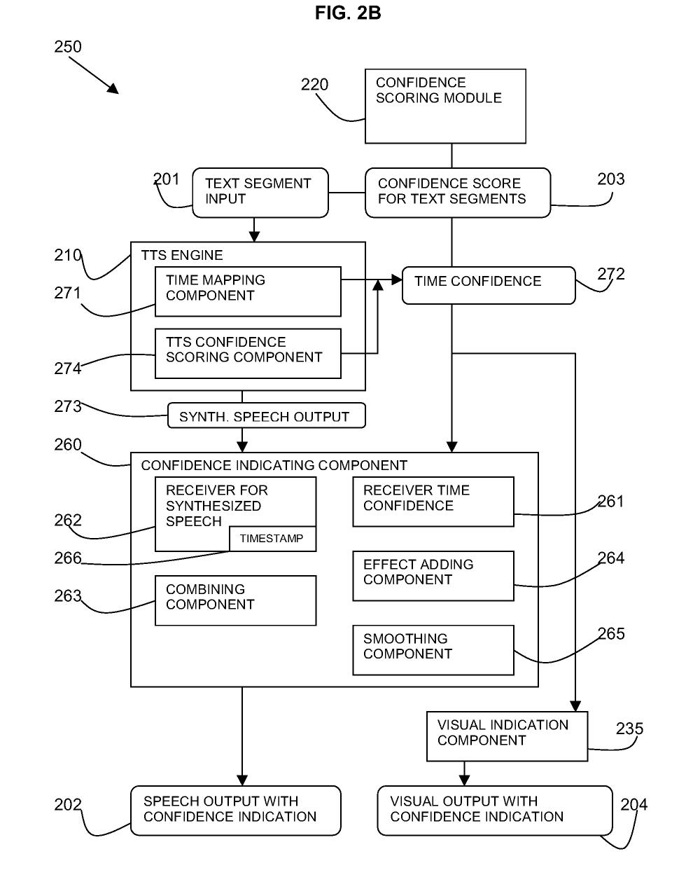

Referring to FIG. 2A, a first embodiment system 200 with a text-to-speech (TTS) engine 210 with a confidence indication is described.

A text segment input 201 is made to a TTS engine 210 for conversion to a speech output 202. A confidence scoring module 220 is provided from processing of the text segment input 201 upstream of the TTS engine 210. For example, the confidence scoring module 220 may be provided in an ASR engine or MT engine used upstream of the TTS engine 210. The confidence scoring module 220 provides a confidence score 203 corresponding to the text segment input 201.

A TTS engine 210 is composed of two parts: a front-end and a back-end. The front-end has two major tasks. First, it converts raw text containing symbols like numbers and abbreviations into the equivalent of written-out words. This process is often called text normalization, pre-processing, or tokenization. The front-end then assigns phonetic transcriptions to each word, and divides and marks the text into prosodic units, like phrases, clauses, and sentences. The process of assigning phonetic transcriptions to words is called text-to-phoneme or grapheme-to-phoneme conversion. Phonetic transcriptions and prosody information together make up the symbolic linguistic representation that is output by the front-end. The back-end, often referred to as the synthesizer, then converts the symbolic linguistic representation into sound.

Synthesized speech can be created by concatenating pieces of recorded speech that are stored in a database. Systems differ in the size of the stored speech units; a system that stores phones or diphones provides the largest output range, but may lack clarity. For specific usage domains, the storage of entire words or sentences allows for high-quality output. Alternatively, a synthesizer can incorporate a model of the vocal tract and other human voice characteristics to create a completely “synthetic” voice output.

The TTS engine 210 includes a receiver 211 for receiving text segment input 201 with a confidence score 203 provided as metadata. A converter 212 is provided for converting the text segments with confidence scores as metadata into text with a markup indication for audio enhancement, for example, using SSML (Synthesized Speech Markup Language).

A synthesizer processor 213 then synthesizes the marked up text. The synthesizer processor 213 includes a confidence indicating component 230.

A confidence indicating component 230 is provided for modifying the synthesized speech generated by the TTS engine 210 to indicate the confidence score for each utterance output in the speech output 202.

The speech output 202 may be modified in one or more of the following audio methods:
Expressive TTS techniques known in the art (see reference J. Pitrelly, R. Bakis, E. Eide, R. Fernandez, W. Hamza and M. Picheny, “The IBM expressive text-to-speech synthesis system for American English”, IEEE Transactions on audio, speech and language processing, vol. 14, no. 4, pp. 1099-1108, 2006) can be used in order to synthesize confident or non-confident speech;
Additive noise whose intensity is inversely proportional to the confidence of the speech may be used;
Voice morphing (VM) technology (see reference Z. Shuang, R. Bakis, S. Shechtman, D. Chazan and Y. Qin, “Frequency warping based on mapping formant parameters”, in Proc. ICSLP, September 2006, Pittsburgh Pa, USA) which changes the voice spectrum and/or its pitch in cases of poor confidence may be used;
Other speech parameters such as jitter, mumbling, speaking rate, volume etc. may be used.

The confidence indicating component 230 includes a text markup interpreter 231, an effect adding component 232 and a smoothing component 233. The interpreter 231 and effect adding component 232 within the synthesizer processor 213 translate the marked up text into speech output 202 with confidence enhancement.

A smoothing component 233 is provided in the confidence indicating component 230 for smoothing the speech output 202. On transition between confidence level segments, the concatenation can apply signal processing methods in order to generate smooth and continuous sentences. For example, gain and pitch equalization and overlap-add at the concatenation points.

In one embodiment, there are a few levels of defined confidence, such as high, medium, and low and each utterance is classified to a specific level. However, there may be more levels defined having better granularity on confidence.

In a multimodal system, a visual indication component 235 may optionally be provided for converting the confidence score to a visual indication for use in a multimodal output system. The visual indication component 235 provides a visual output 204 with an indication of the confidence score. A time coordination between the speech output and visual output is required.

In the embodiment shown in FIG. 2A, the confidence indicating component 230 is provided as part of the TTS engine 210. The text to be synthesized may contain in addition to the text itself, mark-up which contains hints to the engine 210 on how to synthesize the speech. Samples of such mark-ups include volume, pitch, and speed or prosody envelope. Usually, the expressive TTS engine 210 is trained in advance and knows how to synthesize with different expressions; however, the mark-up may be used to override the built-in configuration. Alternatively, the expressive TTS engine 210 may have preset configurations for different confidence levels, or use different voice data sets for each confidence level. The mark-ups can then just indicate the confidence level of the utterance (e.g. low confidence/high confidence).

According to the chosen method to tag the synthesized speech with confidence, the text to be synthesized is augmented with mark-ups to symbol low and high confidence scored utterances.

FIG. 2B shows a second alternative embodiment in which the confidence indicating component is a separate component applied after the speech is synthesized. Different effects may be applied as post-TTS effects. The confidence score is applied in a visual and/or audio indication.

Referring to FIG. 2B, a system 250 is shown in which a confidence indicating component 260 is provided as a separate component downstream of the TTS engine 210.

As in FIG. 2A, text segment inputs 201 are made to a TTS engine 210 for synthesis into speech. The text segment inputs 201 have confidence scores 203 based on scores determined by confidence scoring module(s) upstream of the TTS engine 210.

The TTS engine 210 includes a time mapping component 271 to generate a mapping between each text segment input 201 and its respective time range (either as start time and end time, or start time and duration). The confidence score of the text is thereby transformed to a time confidence with each time period having a single associated confidence value. The time confidence 272 is input to the confidence indicating component 260 in addition to the synthesized speech output 273 of the TTS engine 210.

The TTS engine 210 may optionally include a TTS confidence scoring component 274 which scores the synthesis process. For example, a speech synthesis confidence measure is described in U.S. Pat. No. 6,725,199. Such a TTS confidence score has a timestamp and may be combined with the time confidence 272 input to the confidence indicating component 260.

The confidence indicating component 260 includes a receiver 261 for the time confidence 272 input and a receiver 262 for the synthesized speech output 273 which processes the synthesised speech to generate timestamps. As an audio playback device counts the number of speech samples played, it generates time stamps with an indication of current time. This time is then used to retrieve the respective confidence.

A combining component 263 combines the time confidence score 272 with the synthesized speech output 273 and an effect applying component 264 applies an effect based on the confidence score for each time period of the synthesized speech. Post Synthesis effects might include: volume modification, additive noise or any digital filter. More complex effects such as pitch modification, speaking rate modification or voice morphing may also be carried out post synthesis.

A smoothing component 265 is provided in the confidence indicating component 260 for smoothing the speech output 276. On transition between confidence level segments, the concatenation can apply signal processing methods in order to generate smooth and continuous sentences. For example, gain and pitch equalization and overlap-add at the concatenation points.

A visual indication component 235 may also optionally be provided for converting the confidence score to a visual indication for use in a multimodal output system (for example, a mobile phone with a screen). A visual output 204 is provided with a visual indication of the confidence score corresponding to current speech output.

The visual indication component 235 is updated with the time confidence 272. Since the time regions are increasing, usually the visual gauge is only updated at the beginning of the region. This beginning of the region is named ‘presentation time’ of the respective confidence.

The confidence scoring indication may be provided in a channel separate from the audio channel. For example, Session Description Protocol (SDP) describes streaming multimedia sessions. The confidence scoring indication may alternatively be specified in-band using audio watermarking techniques. In telecommunications, in-band signalling is the sending of metadata and control information in the same band, on the same channel, as used for data.

U.S. Pat. No. 6,674,861 describes a method for adaptive, content-based watermark embedding of a digital audio signal. Watermark information is encrypted using an audio digest signal, i.e. a watermark key. To optimally balance inaudibility and robustness when embedding and extracting watermarks, the original audio signal is divided into fixed length frames in the time domain. Echoes (S′[n], S″[n]) are embedded in the original audio signal to represent the watermark. The watermark is generated by delaying and scaling the original audio signal and embedding it in the audio signal. An embedding scheme is designed for each frame according to its properties in the frequency domain. Finally, a multiple-echo hopping module is used to embed and extract watermarks in the frame of the audio signal.

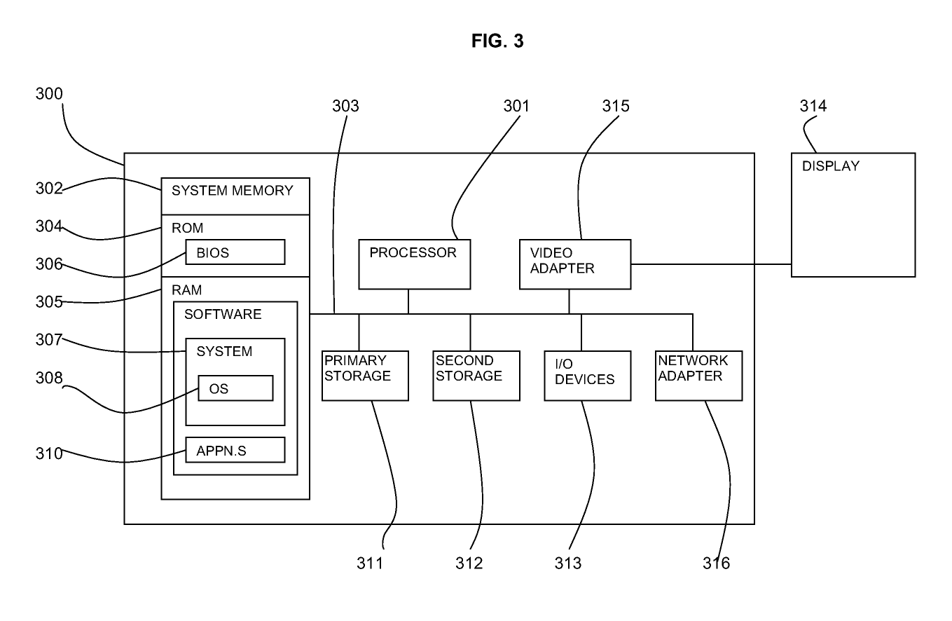

Referring to FIG. 3, an exemplary system for implementing aspects of the invention includes a data processing system 300 suitable for storing and/or executing program code including at least one processor 301 coupled directly or indirectly to memory elements through a bus system 303. The memory elements can include local memory employed during actual execution of the program code, bulk storage, and cache memories which provide temporary storage of at least some program code in order to reduce the number of times code must be retrieved from bulk storage during execution.

The memory elements may include system memory 302 in the form of read only memory (ROM) 304 and random access memory (RAM) 305. A basic input/output system (BIOS) 306 may be stored in ROM 304. System software 307 may be stored in RAM 305 including operating system software 308. Software applications 310 may also be stored in RAM 305.

The system 300 may also include a primary storage means 311 such as a magnetic hard disk drive and secondary storage means 312 such as a magnetic disc drive and an optical disc drive. The drives and their associated computer-readable media provide non-volatile storage of computer-executable instructions, data structures, program modules and other data for the system 300. Software applications may be stored on the primary and secondary storage means 311, 312 as well as the system memory 302.

The computing system 300 may operate in a networked environment using logical connections to one or more remote computers via a network adapter 316.

Input/output devices 313 can be coupled to the system either directly or through intervening I/O controllers. A user may enter commands and information into the system 300 through input devices such as a keyboard, pointing device, or other input devices (for example, microphone, joy stick, game pad, satellite dish, scanner, or the like). Output devices may include speakers, printers, etc. A display device 314 is also connected to system bus 303 via an interface, such as video adapter 315.

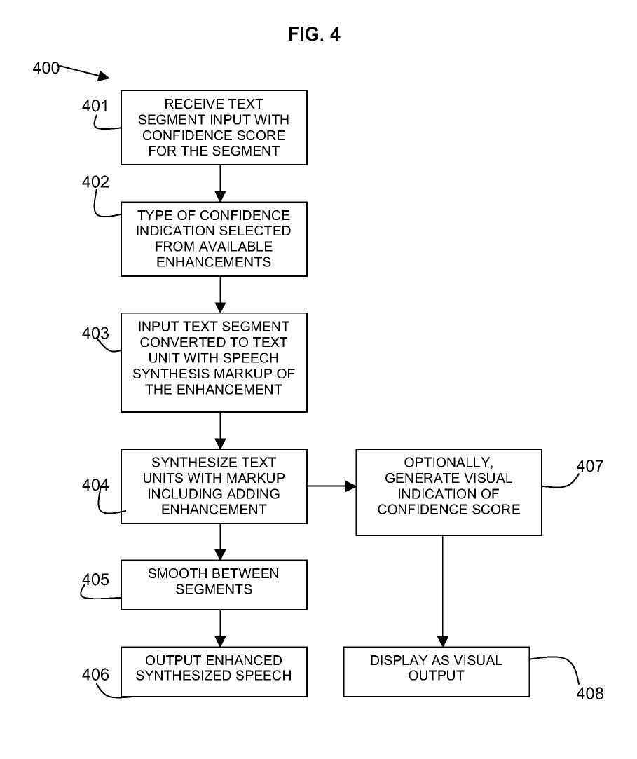

Referring to FIG. 4, a flow diagram 400 shows a first embodiment of a method of speech output with confidence indication. A text segment input is received 401 with a confidence score for the segment. The text segment may be a word, or a sequence of words, up to a single sentence. The confidence score may be provided as metadata for the text segment, for example, in an XML file. Typically, confidence measures are in the range of 0-1, where 0 is low confidence and 1 is maximum confidence. For example:

<phrase confidence=0.9>I want to go to</phrase>

<phrase confidence=0.6>Boston </phrase>

The type of confidence indication is selected 402 from available synthesized speech enhancements.

The input text segment with confidence score is converted 403 to a text unit with speech synthesis markup of the enhancement, for example using Speech Synthesis Markup Language (SSML), see further description below.

The example above may have volume enhancement selected and be converted to: <prosody volume=medium>I want to go to <prosody volume=soft>Boston As the first phrase has higher confidence than the second phrase, it is louder than the second phrase. Similarly, other speech parameters (or combinations of them) may be used.

The text units with speech synthesis markup are synthesized 404 including adding the enhancement to the synthesized speech. A speech segment for output is modified by altering one or more parameters of the speech proportionally to the confidence score.

Smoothing 405 is carried out between synthesized speech segments and the resultant enhanced synthesized speech is output 406.

Optionally, a visual indication of the confidence score is generated 407 for display as a visual output 408 corresponding in time to the speech output 406. The confidence score is presented in a visual gauge corresponding in time to the playback of the speech output.

The W3C specification Speech Synthesis Markup Language specification (SSML) (see http://www.w3.org/TR/speech-synthesis/) is part of a larger set of markup specifications for voice browsers developed through the open processes of the W3C. It is designed to provide a rich, XML-based markup language for assisting the generation of synthetic speech in Web and other applications. The essential role of the markup language is to give authors of synthesizable content a standard way to control aspects of speech output such as pronunciation, volume, pitch, rate, etc. across different synthesis-capable platforms.

A Text-To-Speech system (a synthesis processor) that supports SSML is responsible for rendering a document as spoken output and for using the information contained in the markup to render the document as intended by the author.

A text document provided as input to the synthesis processor may be produced automatically, by human authoring, or through a combination of these forms. SSML defines the form of the document.

The synthesis processor includes prosody analysis. Prosody is the set of features of speech output that includes the pitch (also called intonation or melody), the timing (or rhythm), the pausing, the speaking rate, the emphasis on words and many other features. Producing human-like prosody is important for making speech sound natural and for correctly conveying the meaning of spoken language. Markup support is provides and emphasis element, break element and prosody element, which may all be used by document creators to guide the synthesis processor in generating appropriate prosodic features in the speech output.

The emphasis element and prosody element may be used as enhancement in the described system to indicate the confidence score in the synthesized speech.

### The Emphasis Element

The emphasis element requests that the contained text be spoken with emphasis (also referred to as prominence or stress). The synthesis processor determines how to render emphasis since the nature of emphasis differs between languages, dialects or even voices. The level attribute indicates the strength of emphasis to be applied. Defined values are “strong”, “moderate”, “none” and “reduced”. The meaning of “strong” and “moderate” emphasis is interpreted according to the language being spoken (languages indicate emphasis using a possible combination of pitch change, timing changes, loudness and other acoustic differences). The “reduced” level is effectively the opposite of emphasizing a word. The “none” level is used to prevent the synthesis processor from emphasizing words that it might typically emphasize. The values “none”, “moderate”, and “strong” are monotonically non-decreasing in strength.

### The Prosody Element

The prosody element permits control of the pitch, speaking rate, and volume of the speech output. The attributes are:
pitch: the baseline pitch for the contained text. Although the exact meaning of “baseline pitch” will vary across synthesis processors, increasing/decreasing this value will typically increase/decrease the approximate pitch of the output. Legal values are: a number followed by “Hz”, a relative change or “x-low”, “low”, “medium”, “high”, “x-high”, or “default”. Labels “x-low” through “x-high” represent a sequence of monotonically non-decreasing pitch levels.
contour: sets the actual pitch contour for the contained text. The format is specified in Pitch contour below.
range: the pitch range (variability) for the contained text. Although the exact meaning of “pitch range” will vary across synthesis processors, increasing/decreasing this value will typically increase/decrease the dynamic range of the output pitch. Legal values are: a number followed by “Hz”, a relative change or “x-low”, “low”, “medium”, “high”, “x-high”, or “default”. Labels “x-low” through “x-high” represent a sequence of monotonically non-decreasing pitch ranges.
rate: a change in the speaking rate for the contained text. Legal values are: a relative change or “x-slow”, “slow”, “medium”, “fast”, “x-fast”, or “default”. Labels “x-slow” through “x-fast” represent a sequence of monotonically non-decreasing speaking rates. When a number is used to specify a relative change it acts as a multiplier of the default rate. For example, a value of 1 means no change in speaking rate, a value of 2 means a speaking rate twice the default rate, and a value of 0.5 means a speaking rate of half the default rate. The default rate for a voice depends on the language and dialect and on the personality of the voice. The default rate for a voice should be such that it is experienced as a normal speaking rate for the voice when reading aloud text.
duration: a value in seconds or milliseconds for the desired time to take to read the element contents.
volume: the volume for the contained text in the range 0.0 to 100.0 (higher values are louder and specifying a value of zero is equivalent to specifying “silent”). Legal values are: number, a relative change or “silent”, “x-soft”, “soft”, “medium”, “loud”, “x-loud”, or “default”. The volume scale is linear amplitude. The default is 100.0. Labels “silent” through “x-loud” represent a sequence of monotonically non-decreasing volume levels.

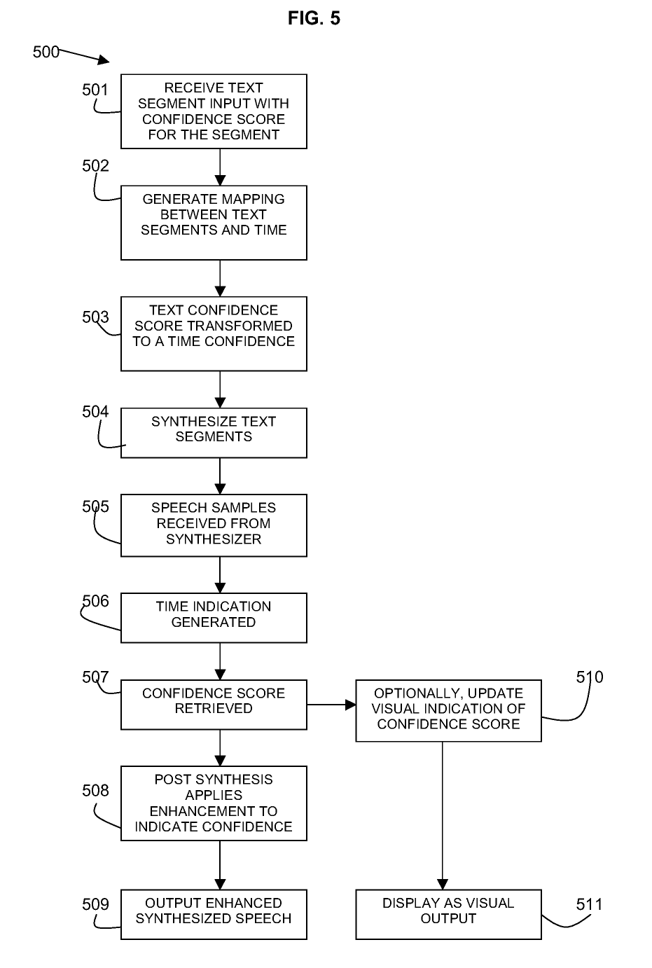

Referring to FIG. 5, a flow diagram 500 shows a second embodiment of a method of speech output with confidence indication including post-synthesis processing.

A text segment input is received 501 with a confidence score. In order to support post synthesis confidence indication, a mapping is generated 502 between each text segment and its respective time range (either as start time and end time, or start time and duration).

The confidence score of the text is thus transformed 503 to a time confidence (either presented as seconds or speech samples). Each time has a single associated confidence value. The time would typically be 0 in the beginning of utterance.

The text segment inputs are synthesized 504 to speech. A post synthesis component receives 505 the speech samples from the synthesizer. As the component counts the number of speech samples received, it generates 506 an indication of time. The number of samples is then used by inverting the above text to samples transformation to retrieve 507 the originating word and thus its respective confidence.

The post synthesis component applies 508 the appropriate operation on the speech samples stream. A speech segment for output is modified by altering one or more parameters of the speech proportionally to the confidence score. As an example, if the effect is gain effect, it would amplify speech segments which originated from high confidence words and mute speech segments originating from words with low confidence. The enhanced speech is output 509.

Optionally, a visual gauge may also be updated 510 with the confidence and a visual output displayed 511. The confidence score is presented in a visual gauge corresponding in time to the playback of the speech output. Since the time regions are increasing, usually the visual gauge is only updated in the beginning of the region. This beginning of region is named ‘presentation time’ of the respective confidence. This is similar to video playback which includes synchronization between sequence of images, each with its own ‘presentation time’ and audio track.

Speech would be typically streamed through a real-time transfer protocol (RTP). Confidence measures would be streamed in another RTP stream (belonging to the same session). The confidence measures would include timestamped ranges with confidence. The RTP receiver would change the visual display to the confidence relevant to this time region.

Current systems do not propagate error information to the output speech. They might mute output below certain confidence level. However, the generated speech looses the confidence information and it might contain speech with high confidence and speech with very low confidence (and misleading content) and the listener can not distinguish one from the other.

A speech synthesis system with confidence indication may be provided as a service to a customer over a network.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for speech output with confidence indication, comprising:
receiving a confidence score for segments of speech or text to be synthesized to speech; and
modifying a speech segment for output by altering one or more parameters of the speech proportionally to the confidence score; wherein said steps are implemented in either:
computer hardware configured to perform said identifying, tracing, and providing steps, or
computer software embodied in a non-transitory, tangible, computer-readable storage medium.

2. The method as claimed in claim 1, including:
presenting the confidence score in a visual gauge corresponding in time to the playback of the speech output.

3. The method as claimed in claim 1, wherein modifying a speech segment for output by altering one or more parameters of the speech proportionally to the confidence score is carried out during synthesis of text to speech.

4. The method as claimed in claim 1, wherein receiving a confidence score for text to be synthesized includes:
receiving a confidence score as metadata of a segment of input text; and
converting the confidence score to a speech synthesis enhancement markup for interpretation by a text-to-speech synthesis engine.

5. The method as claimed in claim 1, including:
receiving segments of text to be synthesized with a confidence score;
synthesizing the text to speech; and
wherein modifying a speech segment for output by altering one or more parameters of the speech proportionally to the confidence score is carried out post synthesis.

6. The method as claimed in claim 1, wherein receiving a confidence score for segments of speech includes:
mapping the confidence score to a timestamp of the speech.

7. The method as claimed in claim 1, wherein receiving a confidence score for segments of the speech includes receiving a confidence score generated by the speech synthesis for segments of synthesized speech.

8. The method as claimed in claim 1, wherein modifying a speech segment by altering one or more parameters of the speech proportionally to the confidence score includes using one of the group of: expressive synthesized speech, added noise, voice morphing, speech rhythm, jitter, mumbling, speaking rate, emphasis, pitch, volume, pronunciation.

9. The method as claimed in claim 1, including:
applying signal processing to smooth between speech segments of different confidence levels.

10. The method as claimed in claim 1, including:
providing the modified speech segments in a separate channel to an audio channel for playback of the synthesized speech.

11. The method as claimed in claim 1, including:
providing the modified speech segments in-band with an audio channel for playback of the synthesized speech.

12. The method as claimed in claim 1, including using audio watermarking techniques to pass confidence information in addition to speech in the same channel.
